(19) United States
(12) Patent Application Publication
(10) Pub. No.: US 2006/0215071 A1
(43) Pub. Date: Sep. 28, 2006

(54) Liquid crystal display and method

(76) Inventors: Ae Shin, Suwon-si (KR); Dong-Gyu Kim, Yongin-si (KR)

Correspondence Address: CANTOR COLBURN, LLP, 55 GRIFFIN ROAD SOUTH, BLOOMFIELD, CT, 06002, US

(21) Appl. No.: 11/386,566

(22) Filed: Mar. 22, 2006

(30) Foreign Application Priority Data
Mar. 22, 2005 (KR) 10-2005-0023586

(51) Int. Cl. G02F 1/136

(52) U.S. Cl. 349/44

(57) ABSTRACT

A liquid crystal display includes a plurality of gate lines extending in a first direction to transmit gate signals and a plurality of data lines extending in a second direction to transmit data voltages. The data lines cross the gate lines. A plurality of thin film transistors are connected to the gate and the data lines, and a plurality of pixel electrodes are connected to the thin film transistors. A passivation layer is formed on the gate and the data lines. A shielding electrode extends along the gate and the data lines such that the shielding electrode overlaps the gate and the data lines, and the shielding electrode overlapping the gate line has a width larger than the width of the gate line. As the shielding electrode completely covers the data and the gate lines, the parasitic capacitance between the data and gate lines and the pixel electrode is reduced, thereby preventing deterioration of the display image quality.

This application claims priority to Korean Patent Application No. 10-2005-0023586, filed on Mar. 22, 2005, and all the benefits accruing therefrom under 35 U.S.C. §119, and the contents of which in its entirety are herein incorporated by reference.

### BACKGROUND OF THE INVENTION

(a) Field of the Invention

The present invention relates to a liquid crystal display.

(b) Description of the Related Art

One of the most extensively and currently used flat panel displays includes a liquid crystal display (“LCD”). An LCD includes two display panels with field generating electrodes such as pixel and common electrodes, and a liquid crystal layer disposed between the panels. An image is displayed when an electric field is generated in the liquid crystal layer by applying voltages to the field generating electrodes. The generated electric field aligns the liquid crystal molecules of the liquid crystal layer and controls the polarization of incident light. In other words, the LCD generates an electric field in the liquid crystal layer by applying voltages to the two electrodes and adjusts the intensity of the electric field to control the transmittance of light passing through the liquid crystal layer, thereby displaying the desired images. In order to prevent deterioration of the liquid crystal layer due to applying the one-directional electric field thereto over a long duration, the polarity of the data voltage with respect to the common voltage is inverted per frame, pixel row, or pixel.

It is important with a common LCD to obtain a reasonable pixel aperture ratio, and for this purpose the pixel electrode and the data line are arranged such that they are located proximate to each other or overlap each other. For this reason, a parasitic capacitance is formed between the pixel electrode receiving the pixel voltage and the data line transmitting the data voltages that are continuously varied, thus causing various defects due to the parasitic capacitance. Using a photolithography process where a light exposure mask is smaller than the active area of the substrate, the substrate is divided into several blocks to conduct the light exposure. In this process, the distance between the pixel electrode and the data line may be slightly altered per respective blocks. For this reason, the parasitic capacitance generated between the pixel electrode and the data line is differentiated per respective blocks, and a stitch failure occurs.

Furthermore, the pixel electrode and the gate line also overlap each other to enhance the pixel aperture ratio, and accordingly, the parasitic capacitance between the pixel electrode and the gate line is increased. Such a parasitic capacitance is varied per respective blocks as with the parasitic capacitance between the data line and the pixel electrode. Consequently, a horizontal stripe spot or screen non-uniformity phenomenon is generated.

### BRIEF SUMMARY OF THE INVENTION

In exemplary embodiments of the present invention, a liquid crystal display minimizes the parasitic capacitance generated between the pixel electrode and the data and gate lines.

In order to minimize the parasitic capacitance generated between the pixel electrode and the data and gate lines, a liquid crystal display includes a plurality of gate lines extended in a first direction to transmit gate signals, and a plurality of data lines extended in a second direction to transmit data voltages. The data lines cross the gate lines, a plurality of thin film transistors are connected to the gate and the data lines, and a plurality of pixel electrodes are connected to the thin film transistors. A passivation layer is formed on the gate and data lines. A shielding electrode extends along the gate and data lines such that it overlaps the gate and data lines. The shielding electrode has a width that is larger than that of the gate line.

The shielding electrode may overlap at least a part of the thin film transistor, and it may cover the entire thin film transistor.

It is preferable that the pixel electrode does not overlap the gate line, but that it is spaced apart from the gate line with a distance therebetween.

A storage electrode may overlap the pixel electrode or the drain electrode to form a storage capacitor. It is preferable that the voltage applied to the storage electrode is substantially the same as the voltage applied to the shielding electrode.

A common electrode may face the pixel electrode and receive a common voltage. It is preferable that the voltage applied to the shielding electrode is substantially the same as the common voltage.

The liquid crystal display may include a polarizing plate having a light transmission axis parallel to or perpendicular to the first direction.

It is preferable that the shielding electrode overlapping the data line has a width that is larger than a width of the data line.

In another exemplary embodiment, a method of forming a liquid crystal display to minimize the parasitic capacitance generated between the pixel electrode and the data and gate lines is disclosed. The method includes extending a gate line in a first direction for transmitting gate signals and extending a data line in a second direction crossing the gate line. The data line transmits data voltages. A thin film transistor is connected to the gate line and the data line. A pixel electrode is connected to the thin film transistor. A passivation layer is formed on the gate line and the data line. A shielding electrode is formed including a first portion extending along the gate line and a second portion extending along the data line such that the shielding electrode overlaps the gate line and the data line, wherein the first portion of the shielding electrode has a width larger than a width of the gate line.

### BRIEF DESCRIPTION OF THE DRAWINGS

The present invention will become more apparent by describing embodiments thereof in detail with reference to the accompanying drawings, in which:

FIG. 1 is a block diagram of an exemplary embodiment of an LCD according to the present invention;

FIG. 2 is an equivalent circuit schematic diagram of an exemplary embodiment of a pixel of an LCD according to the present invention;

FIG. 3 is an equivalent circuit schematic diagram of an exemplary embodiment of a sub-pixel of an LCD according to the present invention;

FIG. 4 is a plan view of an exemplary embodiment of a thin film transistor panel for an LCD according to the present invention;

FIG. 5 is a plan view of an exemplary embodiment of a common electrode panel for an LCD according to the present invention;

FIG. 6 is a plan view of an LCD with the thin film transistor panel shown in FIG. 4 and the common electrode panel shown in FIG. 5; and

FIGS. 7A and 7B are cross-sectional views of the LCD taken along the lines VIIa-VIIa′ and VIIb-VIIb′ of FIG. 6.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Now, exemplary embodiments of LCDs and driving methods thereof according to the present invention will be specifically explained with reference to the accompanying drawings.

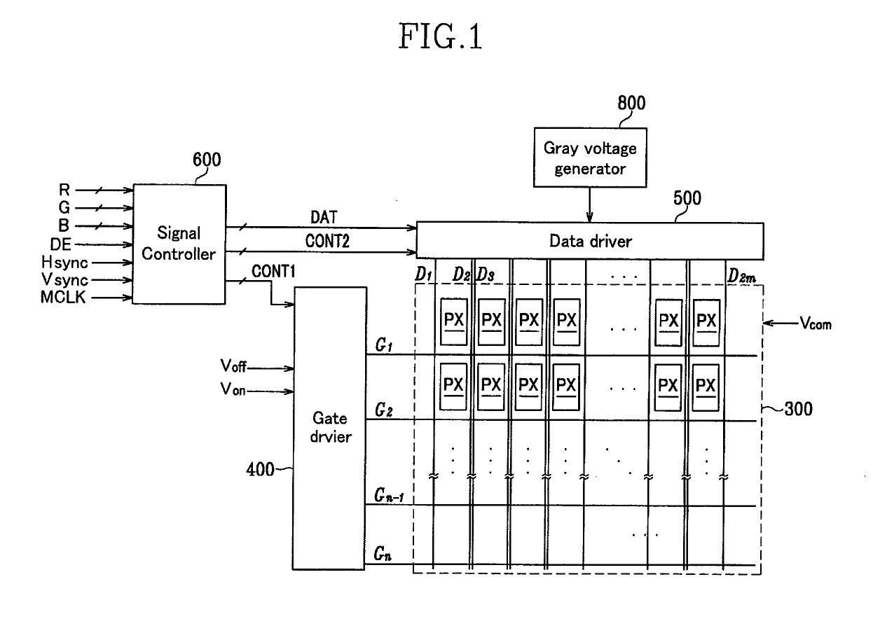

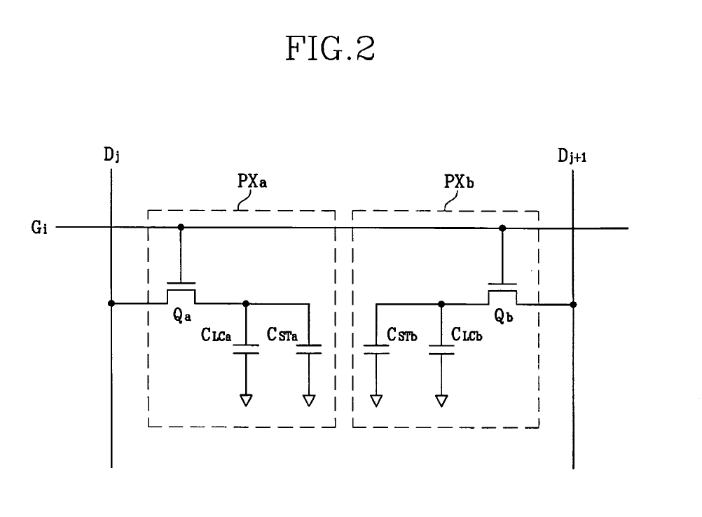

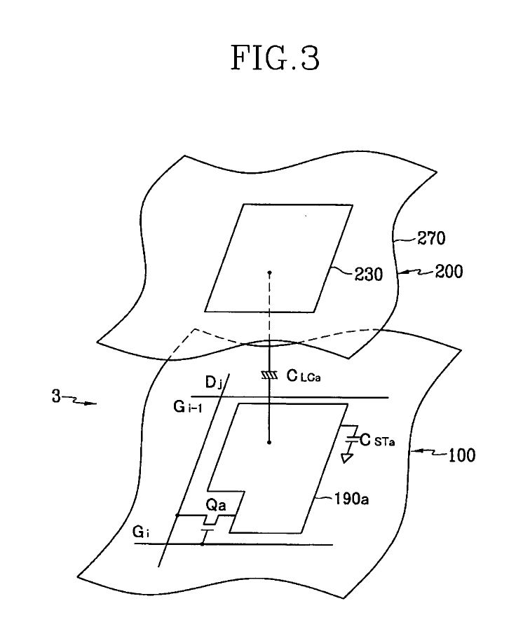

FIG. 1 is a block diagram of an exemplary embodiment of an LCD according to the present invention. FIG. 2 is an equivalent circuit diagram of an exemplary embodiment of a pixel of an LCD according to the present invention. FIG. 3 is an equivalent circuit diagram of an exemplary embodiment of a sub-pixel of an LCD according to the present invention.

As shown in FIG. 1, an exemplary embodiment of an LCD according to the present invention includes a liquid crystal panel assembly 300, a gate driver 400, a data driver 500, a gray voltage generator 800 connected to the data driver 500 and a signal controller 600 for controlling them.

When viewed from an equivalent circuit perspective, the liquid crystal panel assembly 300 includes a plurality of display signal lines G1-Gn and D1-D2m and a plurality of pixels PX connected to the signal lines and arranged in a matrix.

The display signal lines G1-Gn and D1-D2m include a plurality of gate lines G1-Gn for transmitting gate signals (also called the “scanning signals”) and data lines D1-D2m for transmitting data signals. The gate lines G1-Gn extend in the direction of pixel rows parallel to each other, and the data lines D1-D2m extend in the direction of pixel columns parallel to each other and substantially perpendicular to direction of pixel rows. The data lines D1-D2m are arranged at both sides of a pixel PX one by one. Furthermore, the display signal lines may include storage electrode lines in addition to the gate lines G1-Gn and the data lines D1-D2m. The storage electrode lines extend substantially parallel to the gate lines G1-Gn.

As shown in FIG. 2, each of the respective pixels PX include a pair of sub-pixels PXa and PXb, which in turn include switching elements Qa and Qb, respectively, connected to the relevant gate line Gi and relevant data lines Dj and Dj+1, respectively. Liquid crystal capacitors C_{LCa} and C_{LCb} and storage capacitors C_{STa} and C_{STb} are connected to the switching elements Qa and Qb, respectively. The storage capacitors C_{STa} and C_{STb} may be omitted when appropriate. As shown in FIG. 2, the pair of the sub-pixels PXa and PXb are connected to the same gate line Gi, and to different data line neighbors Dj and Dj+1, respectively.

The switching elements Qa and Qb, such as thin film transistors, are provided at a lower panel 100 (FIG. 3), and have a triode structure with control and input terminals connected to the gate lines G1-Gn and the data lines D1-D2m, respectively, and an output terminal connected to the liquid crystal capacitors C_{LCa} and C_{LCb} and storage capacitors C_{STa} and C_{STb}, respectively.

As shown in FIG. 3, the liquid crystal capacitor C_{LCa} of the sub-pixel PXa includes a sub-pixel electrode 190a of the lower panel 100 and a common electrode 270 of an upper panel 200 as two terminals. A liquid crystal layer 3 disposed between the two electrodes 190a and 270 functions as a dielectric for the liquid crystal capacitor C_{LCa} of the sub-pixel PXa. The sub-pixel electrode 190a is connected to the switching element Qa, and the common electrode 270 is formed on the entire surface of the upper panel 200 to receive a common voltage Vcom. Unlike the structure shown in FIG. 3, the common electrode 270 may be provided on the lower panel 100. In this case, at least one of the two electrodes 190a and 270 is linear or bar shaped.

The storage capacitor C_{STa} that is subsidiary to the liquid crystal capacitor C_{LCa} is formed by overlapping the sub-pixel electrode 190a with a separate signal line. For example, the storage capacitor C_{STa} may include a storage electrode line (not shown) provided on the lower panel 100 while interposing an insulator, and a predetermined voltage, such as a common voltage Vcom, is applied to the separate signal line. Alternatively, the storage capacitor C_{STa} may be formed by overlapping the sub-pixel electrode 190a with an adjacent previous gate line while interposing an insulator.

Meanwhile, in order to display colors, the respective pixels should intrinsically express one of the primary colors (spatial division), or alternately express the primary colors in temporal order (time division) such that the desired colors can be perceived by the spatial and temporal sum of the primary colors. The term “primary colors” used herein includes one of three colors such as red, green, and blue colors, for example, and may also be primary colors.

FIG. 3 illustrates an example of the spatial division where the respective pixels have a color filter 230 representing one of the three colors at the area of the upper panel 200. Unlike the structure shown in FIG. 3, the color filter 230 may be formed over or under the sub-pixel electrode 190a of the lower panel 100.

A polarizer (not shown) is attached to the outer surface of at least one of the two panels 100 and 200 of the liquid crystal panel assembly 300 to polarize light.

As shown in FIG. 1, the gray voltage generator 800 generates two sets of gray voltages related to the light transmittance of the sub-pixels PXa and PXb. One set of the gray voltages has a positive value with respect to the common voltage Vcom, and the other set of the gray voltages has a negative value with respect to the common voltage Vcom.

The gate driver 400 is connected to the gate lines G1-Gn of the liquid crystal panel assembly 300 to apply gate signals to the gate lines G1-Gn. The gate signals include combinations of gate on Von and off voltages Voff from the outside.

The data driver 500 is connected to the data lines D1-D2m of the liquid crystal panel assembly 300 to select gray voltages from the gray voltage generator 800 and apply the selected gray voltages to the sub-pixels PXa and PXb as data signals.

The gate driver 400 or the data driver 500 is directly mounted on the liquid crystal panel assembly 300 in the form of a plurality of driving integrated circuit chips, or is mounted on a flexible printed circuit film (not shown) and attached to the liquid crystal panel assembly 300 in the form of a tape carrier package (“TCP”). Alternatively, the gate driver 400 or the data driver 500 may be integrated on the liquid crystal panel assembly 300.

The signal controller 600 controls the operation of the gate driver 400 and the data driver 500.

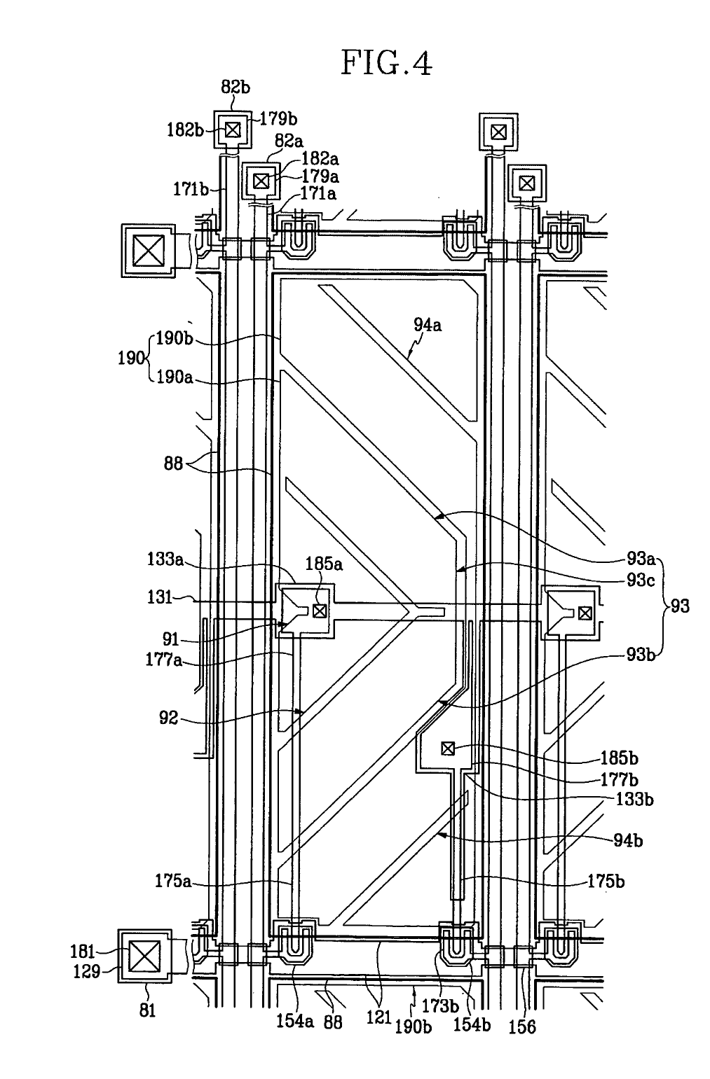

The display operation of the LCD will be now explained in detail with reference to FIGS. 4 to 7B.

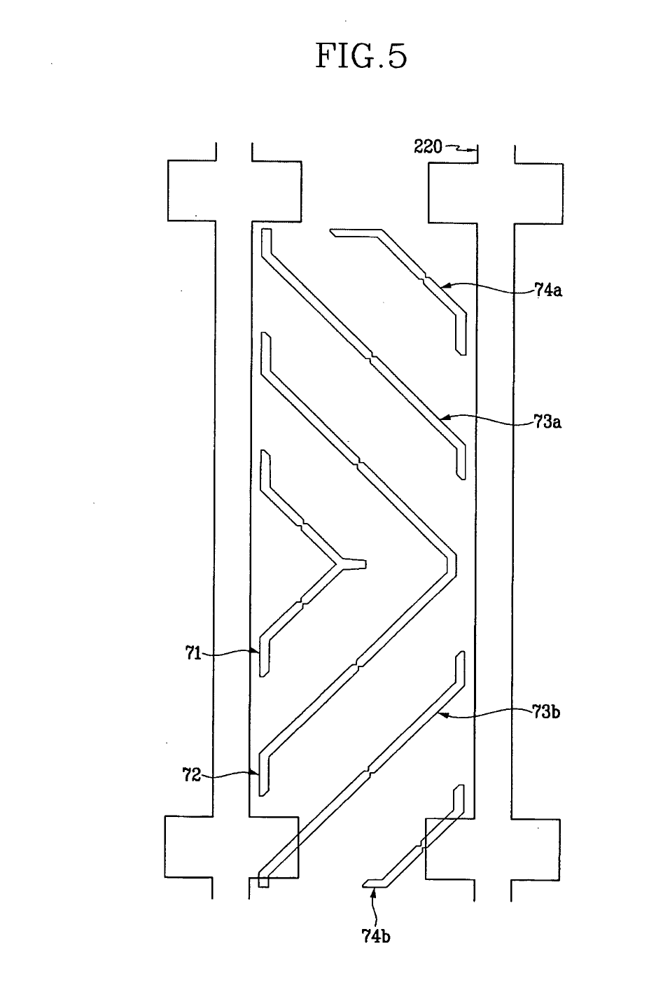

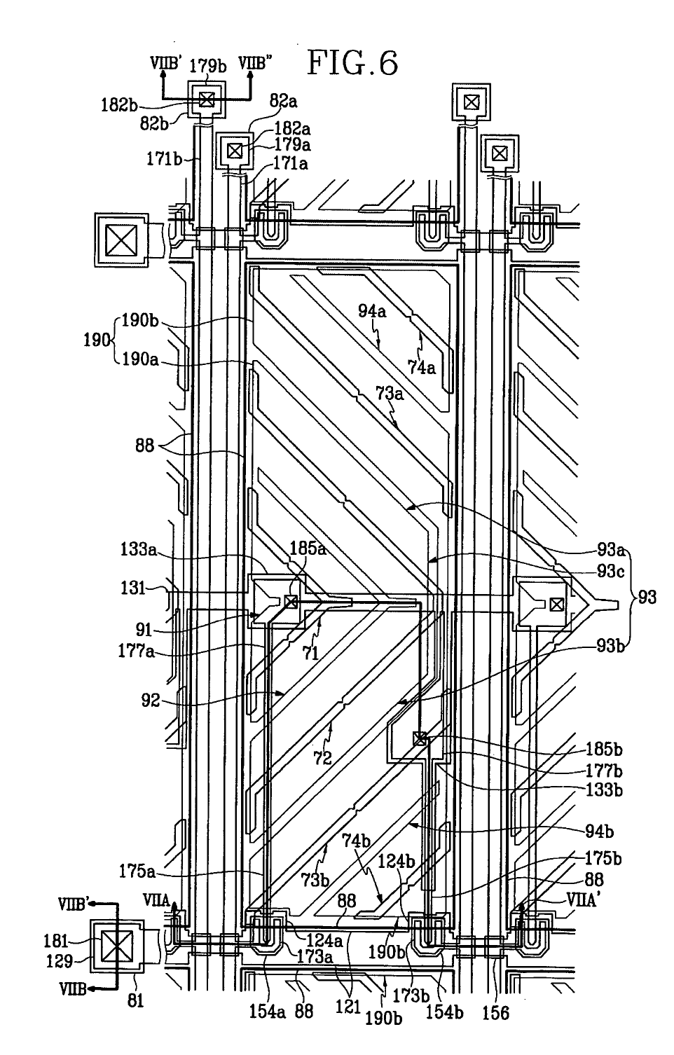

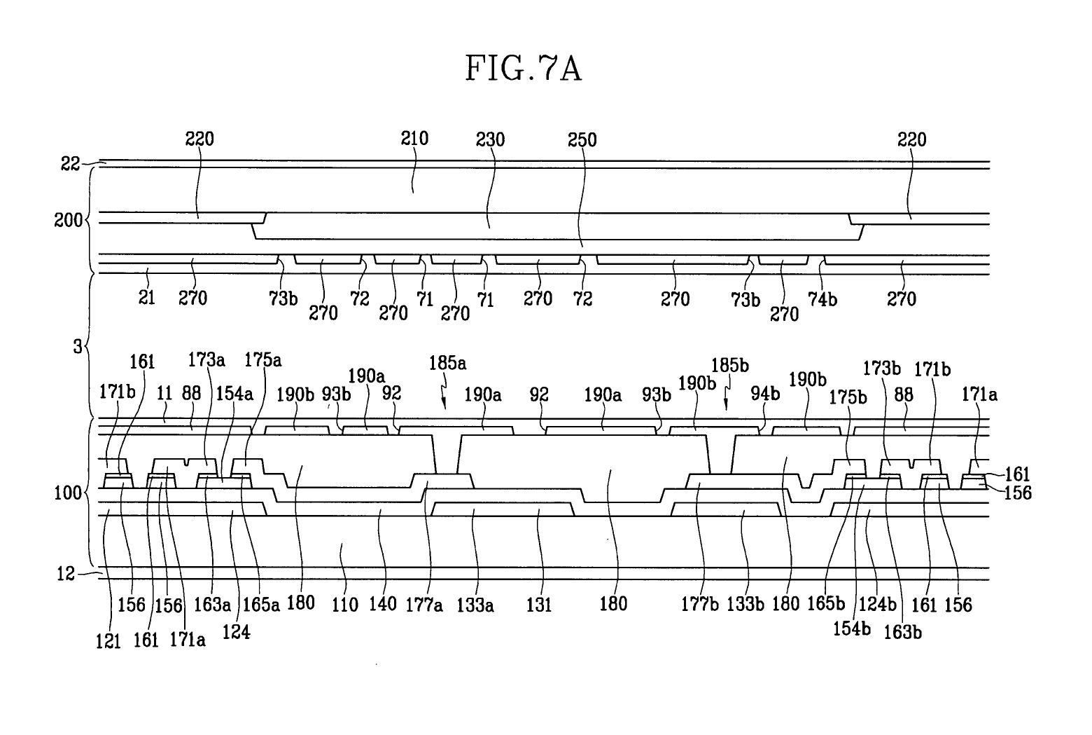

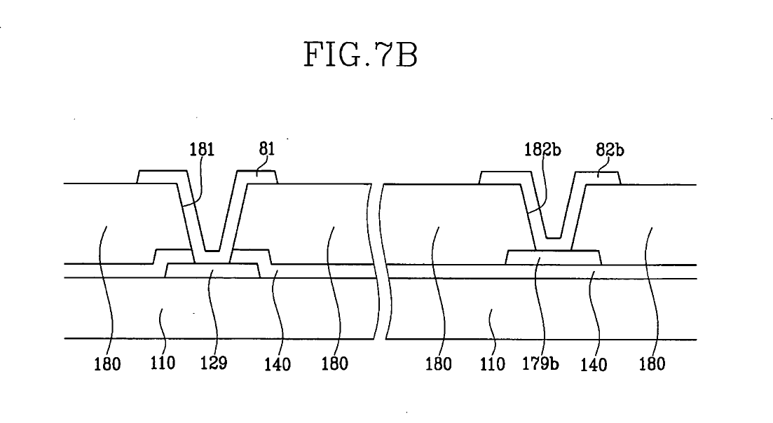

FIG. 4 is a plan view of an exemplary embodiment of a thin film transistor panel for an LCD according to the present invention. FIG. 5 is a plan view of an exemplary embodiment of a common electrode panel for an LCD according to the present invention. FIG. 6 is a plan view of an LCD with the thin film transistor panel shown in FIG. 4 and the common electrode panel shown in FIG. 5. FIGS. 7A and 7B are cross sectional views of the LCD taken along the lines VIIa-VIIa′ and VIIb-VIIb′.

An exemplary embodiment of an LCD according to the present invention includes a thin film transistor panel 100, a common electrode panel 200 and a liquid crystal layer 3 disposed between the two panels 100 and 200.

The thin film transistor panel 100 will first be explained in detail with reference to FIGS. 4, 6, 7A, and 7B.

A plurality of gate lines 121 and a plurality of storage electrode lines 131 are formed on an insulating substrate 110, such as a transparent glass substrate, for example.

The gate lines 121 extend horizontally, as illustrated in FIGS. 4 and 6, and are separated from each other to transmit gate signals. The respective gate lines 121 have a plurality of protrusions forming a plurality of first and second gate electrodes 124a and 124b, and a wide area end portion 129 for connecting with other layers or external devices. Each of the gate lines 121 further has a narrow width portion between neighboring pixels, such that the overlapping area with data lines 171a and 171b to be formed later is reduced, thereby decreasing the interference between the signals applied to the two signal lines.

The storage electrode lines 131 extend horizontally, as illustrated in FIGS. 4 and 6, and have a plurality of first and second storage electrodes 133a and 133b. As best seen with reference to FIG. 4, the first storage electrode 133a is rectangular-shaped to be symmetrical to the storage electrode line 131, and the second storage electrode 133b protrudes vertically from the storage electrode line 131 with an extension. A predetermined voltage is applied to the storage electrode lines 131, such as a common voltage Vcom applied to the common electrode 270 of the common electrode panel 200.

The gate lines 121 and the storage electrode lines 131 are formed with an aluminum-based material such as aluminum (Al) and an aluminum alloy, a silver-based metallic material such as silver (Ag) and a silver alloy, a copper-based metallic material such as copper (Cu) and a copper alloy, a molybdenum-based material such as molybdenum (Mo) and a molybdenum alloy, chromium (Cr), titanium (Ti), or tantalum (Ta). However, the gate lines 121 and the storage electrode lines 131 may have a multi-layered structure with two 0conductive layers (not shown) having different physical properties from each other. One of the conductive layers is formed with a low resistivity material that is capable of reducing the signal delay or voltage drop of the gate lines 121 and the storage electrode lines 131, such as an aluminum-based metallic material, a silver-based metallic material, and a copper-based metallic material. By contrast, the other conductive layer is formed with a material bearing excellent contact characteristics in relation to indium tin oxide (ITO) and indium zinc oxide (IZO), such as a molybdenum-based metallic material, chromium, titanium, and tantalum. Good examples of such a combination include a structure with a chromium-based under layer and an aluminum-based over layer, and a structure with an aluminum-based under layer and a molybdenum-based over layer. However, the gate lines 121 and the storage electrode lines 131 may be formed with other various metallic materials and conductors.

The lateral sides of the gate line 121 and the storage electrode fine 131 are preferably inclined with respect to the surface of the substrate 110 at angle of about 30° to about 80°.

A gate insulating layer 140 is formed on the gate lines 121 and the storage electrode lines 131 with silicon nitride (SiNx).

A plurality of island-shaped semiconductors 154a, 154b, and 156 are formed on the gate insulating layer 140 with hydrogenated amorphous silicon (a-Si). The first and second semiconductors 154a and 154b are formed on the first and second gate electrodes 124a and 124b, respectively. The third semiconductor 156 is formed on the narrow width portion of the gate line 121.

A plurality of island-shaped ohmic contacts 161, 163a, 163b, 165a and 165b are formed on the semiconductors 154a, 154b and 156 with silicide or n+ hydrogenated amorphous silicon where n-type impurities, such as phosphorous, are doped at high concentration. Pairs of the second and third ohmic contacts 163a and 163b (FIG. 7B) and the fourth and fifth ohmic contacts 165a and 165b (FIG. 7B) are placed on the first and second semiconductors 154a and 154b, respectively. The first ohmic contact 161 is placed on the third semiconductor 156.

The lateral sides of the semiconductors 154a, 154b, and 156 and the ohmic contacts 161, 163a, 163b, 165a, and 165b are inclined with respect to the surface of the substrate 110 at angle of about 30° to about 80°.

Referring to FIG. 7A, a plurality of first and second data lines 171 a and 171b, and a plurality of first and second drain electrodes 175a and 175b separated from those data lines are formed on the ohmic contacts 161, 163a, 163b, 165a, and 165b.

The data lines 171a and 171b extend vertically, as illustrated in FIGS. 4 and 6, and cross the gate line 121 and the storage electrode line 131 to transmit data voltages. The first and second data lines 171a and 171b include a plurality of first and second source electrodes 173a and 173b extended toward the first and second drain electrodes 175a and 175b, respectively, and end portions 179a and 179b enlarged in width to make a connection with other layers or external devices.

The first and second drain electrodes 175a and 175b extend vertically, as illustrated in FIGS. 4 and 6, and have extensions 177a and 177b overlapping the first and second storage electrodes 133a and 133b, respectively. The sides of the extensions 177a and 177b of the respective first and second drain electrodes 175a and 175b proceed substantially parallel to the sides of the first and second storage electrodes 133a and 133b, respectively. The first and second source electrodes 173a and 173b are bent or curved such that they surround the bar-shaped end portions of the first and second drain electrodes 175a and 175b, respectively. The first and second gate electrodes 124a and 124b, the first and second source electrodes 173a and 173b, and the first and second drain electrodes 175a and 175b form first and second thin film transistors (TFTs) Qa and Qb together with the semiconductors 154a and 154b, respectively. The channels of the thin film transistors Qa and Qb are formed at the semiconductors 154a and 154b between the first and second source electrodes 173a and 173b and the first and second drain electrodes 175a and 175b, respectively.

The data lines 171a and 171b and the drain electrodes 175a and 175b are preferably formed with chromium, a molybdenum-based metallic material, or a refractory metallic material such as tantalum or titanium. The data lines 171a and 171b, and the drain electrodes 175a and 175b, may have a multi-layered structure with an under layer based on a refractory metallic material (not shown), and an over layer based on a low resistance material (not shown). The multi-layered structure may be a double-layered structure with a chromium or molybdenum-based under layer and an aluminum-based over layer, or a triple-layered structure with a molybdenum-based layer, an aluminum-based layer and a molybdenum-based layer. The distance between the two neighboring data lines 171a and 171b is minimized considering the processing capacity and the production yield, thereby minimizing a reduction in aperture ratio due to the increase in the number of data lines 171a and 171b.

The lateral sides of the data lines 171a and 171b and the drain electrodes 175a and 175b are inclined at an angle of about 30° to about 80° as with the gate line 121 and the storage electrode line 131, as best seen with reference to FIG. 7A.

The ohmic contacts 161, 163a, 163b, 165a and 165b exist only between the underlying semiconductors 156, 154a and 154b, the overlaying data lines 171a and 171b and drain electrodes 175a and 175b to lower the contact resistance therebetween. The island-shaped semiconductors 154a and 154b have substantially the same shape as the source and the drain electrodes 173a, 173b, 175a and 175b and the underlying ohmic contacts 163a, 163b, 165a and 165b, except for the exposed portions thereof between the source electrodes 173a and 173b and the drain electrodes 175a and 175b.

A passivation layer 180 is formed on the data lines 171a and 171b, the drain electrodes 175a and 175b, and the exposed portions of the semiconductors 154a and 154b. The passivation layer 180 is formed with an inorganic material including silicon nitride or silicon oxide, an organic material having excellent flattening characteristic and photosensitivity, or a low dielectric insulating material such as a-Si:C:O and a-Si:O:F formed through plasma enhanced chemical vapor deposition (“PECVD”). Alternatively, the passivation layer 180 may have a double-layered structure with a lower inorganic layer and an upper organic layer to protect the exposed portions of the semiconductors 154a and 154b while sustaining the excellent characteristics of the organic layer.

As best seen with reference to FIGS, 4, 6 and 7B, a plurality of contact holes 182a, 182b, 185a and 185b are formed at the passivation layer 180 to expose the end portions 179a and 179b of the data lines 171a and 171b and the extensions 177a and 177b of the drain electrodes 175a and 175b. A plurality of contact holes 181 are formed at the passivation layer 180 and the gate insulating layer 140 to expose the end portions 129 of the gate lines 121.

A plurality of pixel electrodes 190 with first and second sub-pixel electrodes 190a and 190b, a plurality of shielding electrodes 88 and a plurality of contact assistants 81, 82a and 82b are formed on the passivation layer 180. The pixel electrodes 190, the shielding electrodes 88 and the contact assistants 81, 82a and 82b are formed with a transparent conductor such as ITO and IZO, or a reflective conductor such as aluminum.

First and second sub-pixel electrodes 190a and 190b are physically and electrically connected to the drain electrodes 175a and 175b through the contact holes 185a and 185b to receive data voltages from the drain electrodes 175a and 175b, respectively. Different predetermined voltages are applied to a pair of the sub-pixel electrodes 190a and 190b with respect to one input image signal. The dimension of the data voltages may be varied depending upon the dimension and shape of the sub-pixel electrodes 190a and 190b. The areas of the sub-pixel electrodes 190a and 190b may be different from each other.

The sub-pixel electrodes 190a and 190b receiving the data voltages generate electric fields together with the common electrode 270, thereby aligning the liquid crystal molecules of the liquid crystal layer 3 between the electrodes 190a and 190b, and 270.

Furthermore, as explained earlier, the respective sub-pixel electrodes 190a and 190b and the common electrode 270 form liquid crystal capacitors C_{LCa} and C_{LCb} , respectively, and sustain the applied voltages even after the respective thin film transistors Qa and Qb turn off. In order to reinforce the voltage storage capacity, storage capacitors C_{STa} and C_{STb} are connected to the liquid crystal capacitors C_{LCa} and C_{LCb} in parallel by overlapping the first and second sub-pixel electrodes 190a and 190b with the respective drain electrodes 175a and 175b and the first and second storage electrodes 133a and 133b, respectively, connected thereto.

The respective pixel electrodes 190 are edge-cut at the right corners thereof such that the edge-cut oblique side is inclined against the gate line 121 at an angle of about 450.

A pair of first and second sub-pixel electrodes 190a and 190b forming a pixel electrode 190 engage with each other while having a gap 93 therebetween. The pair of first and second sub-pixel electrodes 190a and 190b forming a pixel electrode 190 with a rectangular-shaped outline. As illustrated in FIGS. 4 and 6, the first sub-pixel electrode 190a is formed in the shape of a rotated equilateral trapezoid with a left side placed around the storage electrode 133a, a right side facing the left side, and upper and lower oblique sides inclined against the gate line 121 at an angle of about 450. The second sub-pixel electrode 190b has a pair of trapezoidal portions facing the oblique sides of the first sub-pixel electrode 190a, and a vertical portion facing the right side of the first sub-pixel electrode 190a. The gap 93 between the first and second sub-pixel electrodes 190a and 190b has a substantially even width, and includes upper and lower oblique portions 93a and 93b, respectively, inclined against the gate line 121 at an angle of about 450 and a vertical portion 93c, substantially with an even width, connected to the upper and lower oblique portions 93a and 93b. For explanatory convenience, the gap 93 will be expressed as a cut portion.

The pixel electrode 190 has central cut portions 91 and 92, upper cut portions 93a and 94a, and lower cut portions 93b and 94b. The pixel electrode 190 is partitioned into a plurality of regions by way of the cut portions 91, 92, 93a, 93b, 94a and 94b. The cut portions 91, 92, 93a, 93b, 94a and 94b are in inversion symmetry with respect to the storage electrode line 131.

Referring to FIGS. 4 and 6, the upper cut portions 93a and 94a and the lower cut portions 93b and 94b are slanted as they extend from the left side of the pixel electrode 190 toward the right side thereof, and are placed at the upper half and the lower half, respectively, of the pixel electrode 190 around the storage electrode line 131 horizontally bisecting the pixel electrode 190. The upper cut portions 93a and 94a and the lower cut portions 93b and 94b extend vertical to each other, and are inclined against the gate line 121 at an angle of about 45°. The central cut portions 91 and 92 are formed with a pair of branches proceeding parallel to the upper cut portions 93a and 94a and the lower cut portions 93b and 94b. The central cut portions 91 and 92 have horizontal portions horizontally extending through the center of the pixel electrode 190.

Consequently, the upper half and the lower half of the pixel electrode 190 are partitioned into four regions by way of the cut portions 91, 92, 93a, 93b, 94a and 94b. The number of partitioned regions or cut portions is varied depending upon the design factors such as the length ratio of the horizontal side to the vertical side of the pixel electrode 190, and the kind and characteristics of the liquid crystal layer 3.

The shielding electrode 88 extends along the data lines 171a and 171b and the gate line 121, as best seen in FIGS. 4 and 6. The shielding electrode 88 overlaps the data lines 171a and 171b and the gate line 121, as best seen with reference to FIG. 7A. The two data lines 171a and 171b and the gate line 121 disposed between the two pixel electrode neighbors 190 are completely covered by the shielding electrode 88. A portion of the source electrodes 173a and 173b and a portion of the gate electrodes 124a and 124b may be exposed to the outside through the shielding electrode 88. The width of the shielding electrode 88 may be made to be smaller than the width of the data lines 171a and 171b and the gate line 121. A common voltage is applied to the shielding electrode 88, and for this purpose, the shielding electrode 88 is connected to the storage electrode line 131 through contact holes (not shown) of the passivation layer 180 and the gate insulating layer 140. The shielding electrode 88 may be connected to a short point (not shown) where the common voltage is transmitted from the thin film transistor panel 100 to the common electrode panel 200. The distance between the shielding electrode 88 and the pixel electrode 190 is as small as possible to minimize the reduction in aperture ratio, as larger distances between the shielding electrode 88 and the pixel electrode 190 reduce the aperture ratio.

When the shielding electrode 88 receiving the common voltage is placed over the data lines 171 a and 171 b, the shielding electrode 88 shields the electric fields formed between the data lines 171a and 171b and the pixel electrode 190, as well as between the data lines 171a and 171b and the common electrode 270, to thereby reduce the voltage distortion of the pixel electrode 190 and the signal delay and distortion of the data voltages transmitted by the data lines 171a and 171b.

Furthermore, as the pixel electrode 190 and the shielding electrode 88 should be spaced apart from each other to prevent short-circuiting thereof, larger distances between the pixel electrode 190 and the data lines 171a and 171b reduces the parasitic capacitance therebetween. Moreover, as the permittivity of the liquid crystal layer 3 is higher than the permittivity of the passivation layer 180, the parasitic capacitance between the data lines 171a and 171b and the shielding electrode 88 is smaller than the parasitic capacitance between the data lines 171a and 171b and the common electrode 270 when the shielding electrode 88 is omitted.

Moreover, as the pixel electrode 190 and the shielding electrode 88 are formed with the same layer, as illustrated in FIG. 7A, the pixel and the shielding electrodes 190 and 88 are spaced apart from each other by a predetermined distance so that the parasitic capacitance therebetween is sustained to be constant.

As with the case of the data lines 171a and 171b, when the shielding electrode 88 is placed over the gate line 121, the pixel electrode 190 and the shielding electrode 88 should be spaced apart from each other to prevent the short-circuiting thereof. Consequently, as the distance between the pixel electrode 190 and the gate line 121 increases, the parasitic capacitance therebetween is reduced. Furthermore, as the pixel electrode 190 and the shielding electrode 88 are formed with the same layer, the pixel and shielding electrodes 190 and 88 are spaced apart from each other by a predetermined distance so that the parasitic capacitance therebetween is sustained to be constant. Moreover, when the gate on voltage Von is applied to the gate line 121, the influence thereof to the pixel is reduced. Accordingly, the deterioration in display image quality, like the horizontal stripe spot phenomenon or the screen non-uniformity phenomenon, can be improved considerably.

Meanwhile, when the shielding electrode 88 is not present over the gate line 121, the common voltage Vcom applied to the shielding electrode 88 may be locally varied due to the capacitive coupling between the data lines 171a and 171b and the overlying shielding electrode 88 with the variation in the electric field of the data lines 171a and 171b. As the shielding electrode 88 according to the present exemplary embodiment continuously extends along the gate line 121 and the data lines 171a and 171b, the shielding electrode 88 also has a role of sustaining the common voltage Vcom applied to the shielding electrode 88 constantly.

The contact assistants 81, 82a and 82b are connected to the end portion 129 of the gate line 121 and the end portions 179a and 179b of the data lines 171a and 171b through the contact holes 181, 182a and 182b, respectively. The contact assistants 81, 82a and 82b reinforce the adhesion of the exposed end portion 129 of the gate line 121 and the exposed end portions 179a and 179b of the respective data lines 171a and 171b to external devices, and protect them.

When the gate and the data drivers 400 and 500, respectively, shown in FIG. 1 are integrated on the thin film transistor panel 100, the gate line 121 and the data lines 171a and 171b may be elongated and connected to those drivers 400 and 500 directly. In this case, the contact assistants 81, 82a and 82b may be used to connect the gate line 121 and the data lines 171a and 171b to the drivers 400 and 500.

Referring to FIG. 7A, an alignment layer 11 is formed on the pixel electrode 190, the contact assistants 81, 82a and 82b, and the passivation layer 180 to align the liquid crystal layer 3. The alignment layer 11 may be a horizontal alignment layer.

The common electrode panel 200 will be now explained with reference to FIGS. 5 to 7A.

A light interceptor 220, called the black matrix, is formed on an insulating substrate 210, such as on transparent glass, to prevent leakage of light. The light interceptor 220 faces the pixel electrodes 190 with a plurality of opening portions having substantially the same shape as the pixel electrodes 190. Alternatively, the light interceptor 220 may be formed with portions corresponding to the data lines 171a and 171b, and portions corresponding to the thin film transistors Qa and Qb. However, the light interceptor 220 may have other various shapes to intercept the light leakage around the pixel electrodes 190 and the thin film transistors Qa and Qb.

A plurality of color filters 230 are formed on the substrate 210. The color filters 230 are mostly located within the regions surrounded by the light interceptor 220, and the color filters 230 extend vertically along the pixel electrodes 190 with reference to FIG. 6. The color filters 230 may express one of three colors such as red, green, and blue colors, and may also be primary colors.

A cover layer 250 is formed on the color filters 230 and the light interceptor 220 to prevent the color filters 230 from being exposed, and to provide a flattened surface covering both.

A common electrode 270 is formed on the cover layer 250 with a transparent conductor such as ITO and IZO.

As best seen with reference to FIGS. 5-7A, the common electrode 270 has a plurality of sets of cut portions 71, 72, 73a, 73b, 74a and 74b.

With reference to FIGS. 5 and 6, a set of the cut portions 71-74b face one pixel electrode 190, and they include central cut portions 71 and 72, upper cut portions 73a and 74a, and lower cut portions 73b and 74b. The cut portions 71-74b are arranged between the cut portion neighbors 91-94b of the pixel electrode 190, as well as between the peripheral cut portions 94a and 94b and the oblique sides of the pixel electrode 190. Furthermore, the respective cut portions 71-74b have at least one inclined or angled portion extending parallel to the cut portions 91 -94b of the pixel electrode 190.

The upper and the lower cut portions 73a -74b have an inclined or angled portion extending from the right side of the pixel electrode 190 to the lower or upper side thereof, and horizontal and vertical portions extending from the respective ends of the inclined portion along the sides of the pixel electrode 190 while overlapping those pixel electrode sides and forming an obtuse angle relative to the inclined portion.

The first central cut portion 71 has a horizontal center portion extending horizontally from the left side of the pixel electrode 190, a pair of inclined or angled portions proceeding from the end of the horizontal center portion toward the left side of the pixel electrode 190 while forming an obtuse angle relative to the horizontal center portion, and vertical end portions proceeding from the ends of the inclined portions along the left side of the pixel electrode 190 and overlapping the left side and obtusely angled against the inclined portions. The second central cut portion 72 includes a vertical portion extending along the right side of the pixel electrode 190 and overlapping the same. The second central cut portion 72 includes a pair of inclined portions extending from respective ends of the vertical portion toward the left side of the pixel electrode 190, and vertical end portions extending from ends of the inclined portions along the left side of the pixel electrode 190 and overlapping the left side and forming an obtuse angle relative to the inclined portions.

V-shaped or triangularly-shaped notches are formed at the inclined portions of the cut portions 71-74b. The notches may be formed in the shape of a rectangle, a trapezoid, or a semicircle, or with a convex or concave shape. The notches determine the alignment direction of the liquid crystal molecules 3 placed at the regional boundaries corresponding to the cut portions 71-74b.

The number of the cut portions 71-74b may be varied depending upon design factors. The light interceptor 220 may overlap the cut portions 71-74b to thereby intercept the leakage of light around the cut portions 71-74b.

At least one of the cut portions 91-94b and 71-74b may be replaced by a protruded or hollowed portion, and the shape and arrangement of the cut portions 91-94b and 71-74b may be varied.

Referring to FIG. 7A, an alignment layer 21 is formed on the common electrode 270 and the cover layer 250 to align the liquid crystal layer 3. The alignment layer 21 may be a horizontal alignment layer.

Polarizing plates 12 and 22 are attached at the outer surfaces of the panels 100 and 200, respectively. The light transmission axes of the two polarizing plates 12 and 22 are perpendicular to each other such that one of the light transmission axes (or an absorption axis) extends in the horizontal direction. In the case of a reflective type of LCD, one of the two polarizing plates 12 and 22 may be omitted.

As the same common voltage is applied to the common electrode 270 and the shielding electrode 88, an electric field is not generated therebetween. Consequently, the liquid crystal molecules located between the common electrode 270 and the shielding electrode 88 are kept in an initial vertical alignment state such that the light incident thereto is not transmitted, but is intercepted.

When the data voltage is charged at the pixel electrode 190, a horizontal electric field is generated between the shielding electrode 88 over the gate line 121 and the pixel electrode 190, and the liquid crystal molecules thereabout are aligned vertical to the shielding electrode 88. The light transmission axes of the polarizing plates 12 and 22 extend parallel or perpendicular to the shielding electrode 88 so that even under the application of the data voltage to the pixel electrode 190, the light incident thereto is not transmitted but is intercepted.

The liquid crystal layer 3 has negative dielectric anisotropy, and therefore, the liquid crystal molecules of the liquid crystal layer 3 are aligned such that the directions thereof are vertical to the surfaces of the two panels when there is no application of an electric field.

When the common voltage is applied to the common electrode 270 and the data voltage is applied to the pixel electrode 190, an electric field is generated substantially vertical or normal to the surfaces of the panels 100 and 200. The cut portions 91-94b and 71-74b of the electrodes 190 and 270 deform such an electric field, and form a horizontal component extending vertical to the sides of the cut portions 91-94b and 71-74b.

Accordingly, the electric field is inclined or angled with respect to the vertical or normal direction to the surfaces of the panels 100 and 200. The liquid crystal molecules are aligned in response to the electric field such that they are directed in a direction of the electric field. The electric fields around the cut portions 91-94b and 71-74b and the sides of the pixel electrode 190 do not extend parallel thereto, but are inclined or angled relative to the long axial direction of the liquid crystal molecules at a predetermined angle so that the liquid crystal molecules are rotated on the plane formed by the long axial direction of the liquid crystal molecules and the electric fields in the short interval movement direction. Consequently, a set of the cut portions 91-94b and 71-74b and the sides of the pixel electrode 190 partition the portion of the liquid crystal layer placed over the pixel electrode 190 into a plurality of domains where the liquid crystal molecules are inclined or angled in different directions, thus enlarging the reference viewing angle.

The operation of the LCD will be now explained in detail.

As shown in FIG. 1, the signal controller 600 receives input image signals R, G, and B and input control signals for controlling the displaying thereof from an external graphic controller (not shown), such as vertical synchronization signals Vsync, horizontal synchronization signals Hsync, main clock signals MCLK and data enable signals DE. The signal controller 600 processes the input image signals R, G, and B based on the input image signals R, G, and B and the input control signals in conformity with the operation conditions of the liquid crystal panel assembly 300, and generates gate control signals CONT1 and data control signals CONT2 to transmit the gate control signals CONT1 to the gate driver 400 and the data control signals CONT2 and the processed image signals DAT to the data driver 500. The conversion of the image signals is done through mappings that are predetermined by experiments and recorded in a lookup table (not shown), or through the operation of the signal controller 600.

The gate control signals CONT1 include scanning start signals STV to instruct a start of the scanning of the gate on voltage Von, and at least one clock signal to control the outputting of the gate on voltage Von.

The data control signals CONT2 include horizontal synchronization start signals STH for informing of the data transmission to a row of sub-pixels PXa and PXb, LOAD signals for applying the relevant data voltages to the data lines D1-D2m, and data clock signals HCLK. The data control signals CONT2 may further include reverse signals RVS for inverting the polarities of the data voltages with respect to the common voltage Vcom (referred to hereinafter simply as the polarities of the data voltages).

The data driver 500 sequentially receives and shifts image data DAT with respect to a row of the sub-pixels PXa and PXb in accordance with the data control signals CONT2 from the signal controller 600. The data driver 500 selects the gray voltages corresponding to the respective image data DAT among the gray voltages from the gray voltage generator 800, and converts the image data DAT into relevant analog data voltages for application to the relevant data lines D1-D2m.

The gate driver 400 sequentially applies gate on voltages Von to the gate lines G1-Gn in accordance with the gate control signals CONT1 from the signal controller 600 to turn on the switching elements Qa and Qb connected to the gate lines G1-Gn. Consequently, the data voltages applied to the data lines D1-D2m are applied to the relevant sub-pixels PXa and PXb through the turned on switching elements Qa and Qb.

The differences between the data voltages applied to the sub-pixels PXa and PXb and the common voltage Vcom are represented by the charge voltages of the respective liquid crystal capacitors C_{LCa} and C_{LCb} , that is, by the sub-pixel voltages. The liquid crystal molecules are re-aligned depending upon the magnitude of the sub-pixel voltages, and accordingly, the polarization of the light passing the liquid crystal layer 3 is varied. The polarization variation is represented by the variation in the light transmittance based on the polarizing plates 12 and 22 attached to the panels 100 and 200.

The input image data is input once and converted into a pair of output image data to give different light transmittances to a pair of the sub-pixels PXa and PXb. Accordingly, the two sub-pixels PXa and PXb exhibit different gamma curves, which are mixed to thereby form a gamma curve of a pixel PX.

When one horizontal cycle or “1H” (a cycle of horizontal synchronization signals Hsync and data enable signals DE) passes by, the data and the gate drivers 500 and 400 repeat the same operation with respect to the next row of sub-pixels PXa and PXb. In this way, the gate on voltages Von are sequentially applied to all of the gate lines G1-Gn for one frame to thereby apply data voltages to all of the sub-pixels PXa and PXb. When one frame terminates, the next frame starts, and the reverse signal RVS applied to the data driver 500 is controlled such that the polarities of the data voltages applied to the respective sub-pixels PXa and PXb are opposite to those polarities in the previous frame (called “frame inversion”). The polarities of the data voltages flowing along one data line may be inverted even within one frame depending upon the characteristic of the reverse signals RVS (called “row inversion,” or “dot inversion”).

It is explained according to an exemplary embodiment of the present invention that a pixel is divided into a pair of sub-pixels with the structure of a shielding electrode for an LCD, but the shielding electrode may be similarly applied to the LCD where the pixel is not divided into sub-pixels.

As described above, with the inventive structure, the shielding electrode completely covers data and gate lines so that the parasitic capacitance between the data and gate lines and the pixel electrode can be reduced, and accordingly, deterioration of the display image quality can be prevented.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A liquid crystal display comprising:
a gate line extending in a first direction and transmitting gate signals;
a data line extending in a second direction, the data line transmitting data voltages and crossing the gate line;
a thin film transistor connected to the gate line and the data line;
a pixel electrode connected to the thin film transistor;
a passivation layer formed on the gate line and the data line; and
a shielding electrode including a first portion extending along the gate line and a second portion extending along the data line such that the shielding electrode overlaps the gate line and the data line,
wherein the first portion of the shielding electrode has a width larger than a width of the gate line.

2. The liquid crystal display of claim 1, wherein the shielding electrode overlaps at least a portion of the thin film transistor.

3. The liquid crystal display of claim 1, wherein the shielding electrode covers the entire thin film transistor.

4. The liquid crystal display of claim 1, wherein the pixel electrode is spaced apart from the gate line.

5. The liquid crystal display of claim 1, further comprising a storage electrode overlapping the pixel electrode or the drain electrode to form a storage capacitor.

6. The liquid crystal display of claim 5, wherein a voltage applied to the storage electrode is substantially the same as a voltage applied to the shielding electrode.

7. The liquid crystal display of claim 1, further comprising a common electrode facing the pixel electrode and supplied with a common voltage.

8. The liquid crystal display of claim 7, wherein a voltage applied to the shielding electrode is substantially the same as the common voltage.

9. The liquid crystal display of claim 1, further comprising a polarizing plate having a light transmission axis extending parallel or perpendicular to the first direction.

10. The liquid crystal display of claim 1, wherein the second portion of the shielding electrode has a width larger than a width of the data line.

11. A method of forming a liquid crystal display, the method comprising:
extending a gate line in a first direction for transmitting gate signals;
extending a data line in a second direction crossing the gate line, the data line transmitting data voltages;
connecting a thin film transistor to the gate line and the data line;
connecting a pixel electrode to the thin film transistor;
forming a passivation layer on the gate line and the data line; and
forming a shielding electrode including a first portion extending along the gate line and a second portion extending along the data line such that the shielding electrode overlaps the gate line and the data line,
wherein the first portion of the shielding electrode has a width larger than a width of the gate line.

12. The method of claim 11, further comprising overlapping at least a portion of the thin film transistor with the shielding electrode.

13. The method of claim 11, further comprising covering the entire thin film transistor with the shielding electrode.

14. The method of claim 11, further comprising spacing apart the pixel electrode from the gate line.

15. The method of claim 11, further comprising overlapping the pixel electrode or the drain electrode with a storage electrode to form a storage capacitor.

16. The method of claim 15, further comprising supplying substantially a same voltage to the storage electrode and the shielding electrode.

17. The method of claim 11, further comprising:
disposing a common electrode to face the pixel electrode; and
supplying the common electrode with a common voltage.

18. The method of claim 17, further comprising supplying voltage to the shielding electrode that is substantially the same as the common voltage.

19. The method of claim 11, further comprising disposing a polarizing plate on an exposed side of a substrate having the gate and data lines extending thereon, the polarizing plate having a light transmission axis extending parallel or perpendicular to the first direction.

20. The method of claim 11, further comprising forming the second portion of the shielding electrode with a width larger than a width of the data line.
